(19) United States
(12) Patent Application Publication
(10) Pub. No.: US 2025/0284494 A1
(43) Pub. Date: Sep. 11, 2025

(54) ENHANCED GLOBAL FLAGS FOR SYNCHRONIZING COPROCESSORS IN PROCESSING SYSTEM

(71) Applicant: Tesla, Inc., Austin, TX (US)

(72) Inventors: Peter Sassone, Austin, TX (US); Gagandeep Sachdev, Austin, TX (US); Peter Joseph Bannon, Austin, TX (US)

(21) Appl. No.: 18/858,922

(22) PCT Filed: Apr. 27, 2023
(86) PCT No.: PCT/US2023/020209

§ 371 Date: Oct. 22, 2024

Related U.S. Application Data
(60) Provisional application No. 63/336,718, filed on Apr. 29, 2022.

(51) Int. Cl. G06F 9/30

(52) U.S. Cl. CPC G06F 9/30087

(57) ABSTRACT

Systems and methods for enhanced global flags for synchronizing coprocessors. An example processor system includes a plurality of coprocessors configured to compute a processing task, wherein individual coprocessors are connected to individual remaining coprocessors via a plurality of connections, wherein each connection from a coprocessor to a different coprocessor is configured to be asserted, or de-asserted, to indicate a status associated with a global flag of a plurality of global flags, and wherein the global flag is set based on the plurality of coprocessors asserting the global flag.

### CROSS-REFERENCE TO RELATED APPLICATIONS

This application claims priority to U.S. Prov. Patent App. No. 63/336,718 filed on Apr. 29, 2022 and titled “ENHANCED GLOBAL FLAGS FOR SYNCHRONIZING COPROCESSORS IN PROCESSING SYSTEM,” the disclosure of which is hereby incorporated herein by reference in its entirety.

### BACKGROUND

TECHNICAL FIELD

The present disclosure relates to synchronizing processors and more particularly to use of global flags for synchronizing processors.

### DESCRIPTION OF RELATED ART

Machine learning models, such as neural networks, are increasingly being relied upon as the foundation of modern software and hardware innovations. Indeed, neural networks may be used for image analysis and classification techniques to recommendation engines utilized to enhance end-user content consumption. Certain innovations may rely upon the vast computing power afforded by a remote cloud system. For example, machine learning processing may be offloaded to a remote cloud system such that the end-user's devices may not need complicated neural network processors. These remote cloud systems may include specialized neural processors which are capable of rapidly performing forward passes through complex deep learning models.

However, other innovations may benefit from being run on end-user devices. For example, an autonomous vehicle may include specialized graphics or neural processors which are able to process complex deep learning models using locally obtained sensor data (e.g., images). As another example, a user's smartphone may include graphics or neural processors to locally perform image classification techniques. For this example, the smartphone may associate persons detected in images captured by the smartphone with specific people.

Due to the increased reliance on specialized processors, there is a need for enhancements in the operation, and design, of these processors to increase a speed at which they can compute machine learning models.

### BRIEF DESCRIPTION OF THE DRAWINGS

FIG. 1A is a block diagram illustrating an example processor system which includes a multitude of coprocessors and uses global flags.

FIG. 1B is a block diagram illustrating the coprocessors in communication with an operating system.

FIG. 2A is a block diagram illustrating a shared mask usable to select a subset of the coprocessors to use global flags.

FIG. 2B is a block diagram illustrating an example of the shared mask selecting a subset of the coprocessors to use global flags.

FIG. 3 is a flowchart of an example process for using global flags by an example processor system.

FIG. 4 is a block diagram illustrating an example vehicle which includes the processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes techniques to synchronize processors, such as coprocessors, included in a processing system. The coprocessors, as an example, may be neural processing units which can rapidly perform operations associated with processing neural networks (e.g., computing forward passes). As will be described, one or more inter-coprocessor flags (e.g., global flags) may be used to synchronize tasks being performed, at least in part, by the coprocessors. These flags may advantageously be asynchronous to reduce an extent to which complexity, such as hardware or software complexity, is required to enable such synchronization of coprocessors.

Embodiments of the processing system described herein include a multitude of coprocessors to perform specialized processing, such as processing related to machine learning models (e.g., neural networks). One or more central processing units may thus offload, at least in part, processing related to neural networks to these coprocessors. In some embodiments there may be 3 coprocessors. In some embodiments there may be 2, 5, 8, and so on coprocessors.

As may be appreciated, processing of neural networks may require substantially large data and computer models. For example, and with respect to the example of an autonomous vehicle, the coprocessors may receive sensor data from a multitude of cameras or sensors positioned about the vehicle. In this example, the sensor data may be received at a particular frequency (e.g., 30 Hz, 60 Hz, and so on) and may be combined or otherwise aggregated for processing. With respect to a convolutional neural network, volumes of filters may be convolved with this received sensor data.

Due to the size of the data involved, and/or complexity associated with processing the data at the particular frequency, the coprocessors may be assigned portions of a processing task (e.g., a computation problem). For example, a first coprocessor may receive a portion of the data. In this example, the first coprocessor may thus determine a processing result associated with the portion. Similarly, other coprocessors may determine processing results associated with remaining portions. These portions may then be aggregated, or otherwise combined, to determine a final processing result associated with the processing task. As another example, the first coprocessor may determine a processing result and the second and third coprocessors may utilize that processing result in their own processing. Thus, the second and third coprocessors may require a technique by which they receive information indicating completion of the processing result.

A first example approach to synchronize coprocessors, such as to synchronize the above-described processing task, may rely upon software synchronization techniques. For example, software synchronization may be used with interrupts to a control central processing unit (CPU). However, this first example approach is cumbersome; especially if the control CPU is running a full operating system rather than a microkernel. For example, interrupt latencies may cause the communication of dependencies between coprocessors to be slow.

To ensure proper synchronization of the above-described coprocessors, while limiting the extent to which additional hardware and/or software complexity is required, this application describes use of global flags. Each coprocessor may be connected with the remaining coprocessors, for example via asynchronous connections or wires. In some embodiments, this may be referred to as an all to all connection between the coprocessors. As will be described, there may be a multitude of connections (e.g., ‘N’ connections) between each processor and individual remaining processors. With respect to the example of N connections, there may be N flags which are able to be set by the coprocessors.

As an example, with respect to a first flag, each coprocessor may assert the first flag. The coprocessors may be operating on a problem which is too large for a single coprocessor to work on. Due to interdependencies between data or operations, these coprocessors may therefore have to complete their respective portions of computations associated with the problem. In some embodiments, asserting the first flag may indicate that a coprocessor has completed their respective portions of computations. For example, asserting the first flag may indicate the completion of an intermediate result by a coprocessor. The first flag may be subsequently cleared (e.g., de-asserted) to indicate that another actor (e.g., another coprocessor, a central processing unit) has successfully received (e.g., copied out) the intermediate result.

In some embodiments, asserting the first flag may indicate that a coprocessor has initiated work on their respective portions of computations. Upon completion, the coprocessor may subsequently de-assert the first flag.

With respect to asserting the above-described first flag, each coprocessor may asynchronously assert the first flag. As described above, the coprocessors may be connected to each other such that each coprocessor receives the asserted first flag from all remaining coprocessors. The assertion by a coprocessor may represent, for example, setting of a value (e.g., logical one) on an asynchronous wire connected to another coprocessor.

The flags may therefore represent an enhanced, and architecturally simplified, extension of dependency flags which may, as an example, be used for local data dependencies. Thus, the flags may be extended to the hardware of the coprocessors through use of wires connecting the coprocessors. In this way, complex problems may be separated and operated upon by coprocessors while data dependencies are respected.

In some embodiments, a central processing unit (CPU) may form part of the flag assertion technique described herein. The CPU, as an example, may receive from, and transmit to, the coprocessors. For example, the CPU may assert the above-described first flag. In this example, the CPU may write an assertion to a first register (e.g., a control register) which is routed to the coprocessors. Additionally, the CPU may read from a second register (e.g., an interrupt register) to identify a status of the first flag as asserted, or de-asserted, by a coprocessor. Status, in this application may indicate whether the first flag has been asserted or de-asserted. In this way, the CPU may identify a status associated with a processing task separated amongst coprocessors. Additionally, the CPU may assert one or more flags based on a processing task the CPU is performing. For example, the CPU may be used to fetch data from memory. In this example, the CPU may assert one or more flags upon completion of the memory fetch.

### Block Diagrams

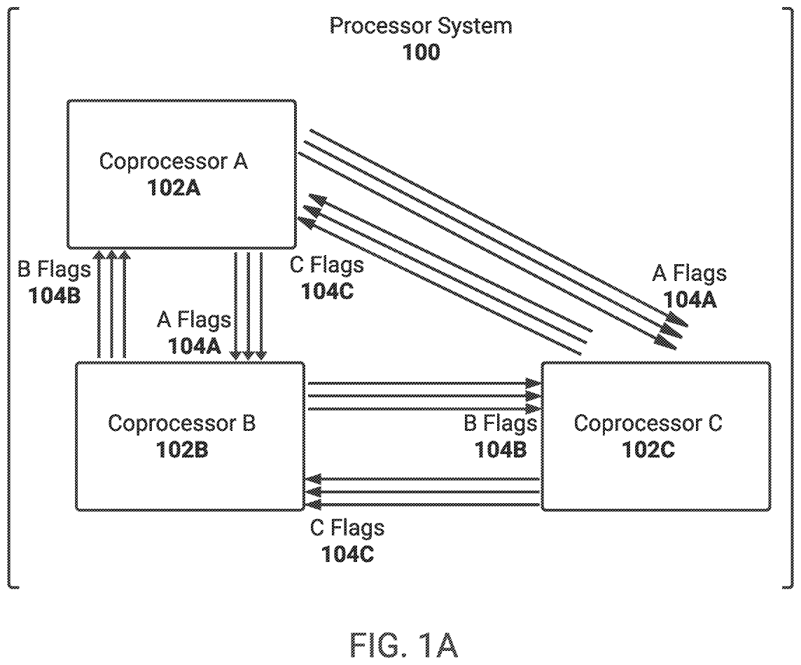

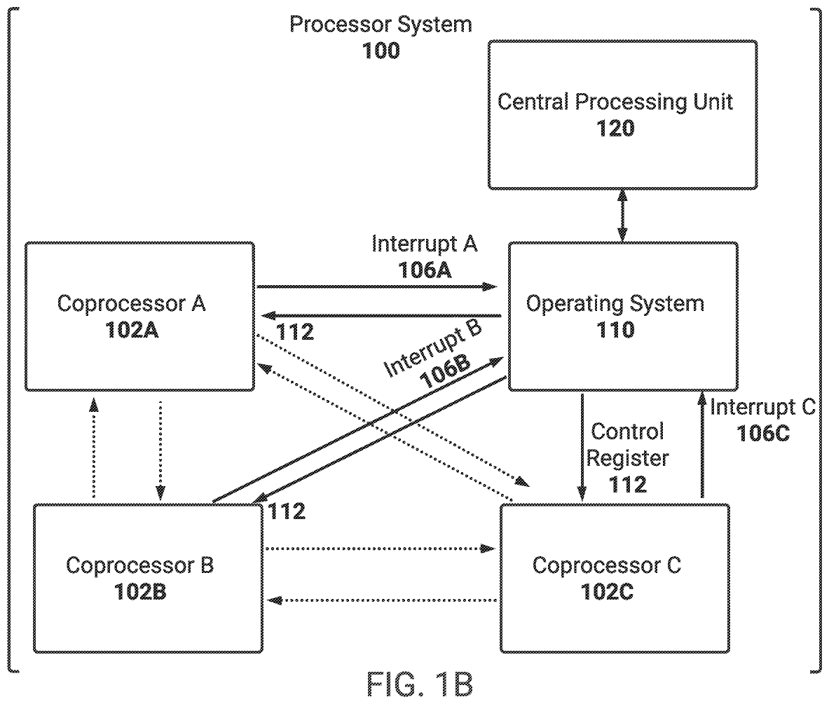

FIG. 1A is a block diagram illustrating an example processor system 100 which includes a multitude of coprocessors 102A-102C and uses global flags 104A-104C. In the illustrated embodiment, the coprocessors 102A-102C may represent neural processing units. In some embodiments, however, the coprocessors 102A-102C may be used to perform arbitrary operations associated with breaking up a computation problem, or problems, in smaller chunks or pieces. While three coprocessors 102A-102C are illustrated in FIG. 1A, in some embodiments there may be 5, 6, 8, and so on, coprocessors.

The processor system 100 may represent, in some embodiments, a system included in a vehicle. For example, the processor system 100 may be used, at least in part, to perform autonomous or semi-autonomous driving of the vehicle. In this example, the processor system 100 may obtain sensor data from sensors (e.g., image sensors) positioned about the vehicle. The sensor data may then be analyzed, for example, using one or more machine learning models. At least a portion of the processing of the machine learning models may be effectuated via the coprocessors 102A-102C.

As illustrated, coprocessor A 102A is connected to coprocessor B 102B and coprocessor C 102C via a multitude of connections. As an example, a portion of the connections between coprocessor A 102A and coprocessor B 102B represent connections for a multitude of flags (e.g., A flags 104A) which may be asserted, or de-asserted, by coprocessor A 102. Similarly, a portion of the connections between coprocessor A 102A and coprocessor C 102C represent connections for the A flags 104A.

Thus, each coprocessor may assert, or de-asserted, a multitude of flags. For example, coprocessor A 102A may control the status for A flags 104A. As another example, coprocessor B 102B may control the status for B flags 104B. As another example, coprocessor C 102C may control the status for C flags 104C. These flags 104A-104C collectively form a multitude of flags which may be collectively asserted, or de-asserted, by the coprocessors 102-102C. For example, there may be 3 flags, 5, flags, 9 flags, 15 flags, and so on. In this example, and with respect to 3 flags, the A flags 104A may represent the status of each of the flags as asserted, or de-asserted, by coprocessor A 102A. The B flags 104B may represent the status of each of the flags as asserted, or de-asserted, by coprocessor B 102B. The C flags 104C may represent the status of each of the flags as asserted, or de-asserted, by coprocessor C 102C.

In this way, the coprocessors may collectively utilize the multitude of flags to represent different data dependencies, processing dependencies, times at which the coprocessors have collectively completed respective calculations associated with a computation task or problem, and so on. In some embodiments, a flag is set (e.g., enabled) if all coprocessors 102A-102C have asserted the flag. With respect to a first flag, the first flag may be set if coprocessor A 102A has asserted the first flag as included in the A flags 104A and coprocessor B 102B has asserted the first flag as included in the B flags 104B and coprocessor C 102C has asserted the first flag as included in the C flags 104C. Since these coprocessors 102A-102C are connected to each other, for example via asynchronous wires, each coprocessor may receive information from the remaining coprocessors indicating the assertion of the first flag.

As may be appreciated, the above-described first flag may be set according to instructions being executed by the coprocessors 102A-102C. For example, software instructions may be associated with a computation task. In this example, the computation task may be separated into portions of operations or sub-tasks. As an example, a compiler may perform the separation, or the separation may be performed in substantially real-time during operation of the processor system 100. For certain computation tasks there may be data dependencies which are introduced when the tasks are separated.

As an example, there may be data which is processed by the coprocessors 102A-102C which, subsequently, is used to determine a processing result. Thus, the processing result depends on the processing being performed by each coprocessor. With respect to the first flag described above, the coprocessors 102A-102C may assert the first flag when finished with their respective processing. Thus, this first flag may be associated with determining the processing result. Similarly, other flags may be associated with other data dependencies. Thus, the coprocessors may ensure that data dependencies, data movement, and so on, are constrained according to the flags.

In some embodiments, a flag may be de-asserted when all coprocessors 102A-102C de-assert the flag. For example, and with respect to the above-described first flag, coprocessors 102A-102C may de-assert the first flag subsequent to removal of a dependency associated with the first flag. Example dependencies, as described above, may relate to data dependencies, processing dependencies, and so on.

As another example, there may be a computation task (e.g., workload) which has a large working set at the beginning but then tapers to a smaller working set toward the end. This computation task may be initiated on the coprocessors 102A-102C with each getting about ⅓ of the input data. Subsequently, for example during about a middle of the computation task, as the working set is reducing in size each coprocessor may assert a global flag. Since, in some embodiments, the coprocessors may not be working in lockstep, each coprocessor may assert the global flag at a different time. For example, a particular coprocessor may have a different program which waits on the global flag to be true. In this example, once the global flag is set (e.g., asserted by all coprocessors), then all coprocessors will have reached a same point.

The particular coprocessor may then obtain (e.g., direct memory access) respective intermediate results from the remaining coprocessors into its own local memory. The particular coprocessor can then de-assert its global flag, or set a different global flag, to indicate to the remaining coprocessors that it has successfully copied the data, and the remaining coprocessors can terminate their workload based on that flag change and optionally receive a new workload (e.g., from a task scheduler). The particular coprocessor can proceed with the remainder of the workload on its own until completion.

FIG. 1B is a block diagram illustrating the coprocessors 102A-102C in communication with an operating system 110. As described in FIG. 1A, coprocessors 102A-102C may control the statuses of a multitude of flags. For example, each coprocessor may assert, or de-assert, flags to collectively cause the flags to be set (e.g., enabled) or un-set (e.g., disabled). In some embodiments, the operating system 110 being executed by the processor system 100 may allow for a central processing unit 120 to take part in setting, or unsetting, flags.

In the illustrated example, the operating system 110A is routing statuses of flags to the coprocessors 102A-102C. For example, the central processing unit 120 may assert, or de-assert, the flags based on writing to one or more control registers. In this example, the central processing unit 120 may interface with the control registers which are mapped to global physical addresses at the system level. Thus, the operating system 110 may provide information from these control registers to the coprocessors 102A-102C.

Similarly, the operating system 110 may route statuses of the flags as set, or unset, by the coprocessors 102A-102C via one or more interrupts. For example, the central processing unit 120 may receive the statuses via one or more interrupt registers. In this example, the coprocessors 102A-102C may provide information via these interrupt registers which are read by the central processing unit 120. Optionally, the central processing unit 120 may request the statuses of the flags from the coprocessors 102A-102C. For example, in contrast to the coprocessors 102A-102C providing interrupts based on asserting, or de-asserting, the flags, the central processing unit 120 may request the statuses. In response, the operating system 110 may provide information to the central processing unit 120 regarding the statuses. In some embodiments, the coprocessors 102A-102C may provide an interrupt upon any change in a flag. For example, if the coprocessors 102A-102C collectively assert a flag then the assertion may cause an interrupt to be triggered to the central processing unit 120.

In this way, the central processing unit 120 may engage with the coprocessors 102A-102C in asserting flags. Thus, the central processing unit 120 may take part in ensuring that dependencies are enforced. For example, one, or all, of the coprocessors 102A-102C may require data which is to be used in processing a computation task. In this example, the central processing unit 120 may fetch the data and indicate completion of the fetching via asserting one of the flags. Without being constrained by way of example, as may be appreciated there may be numerous computation tasks in which the central processing unit 120 is to be involved. For example, the central processing unit 120 may obtain sensor data every at a threshold frequency from a multitude of sensors for use by the coprocessors. In this example, the coprocessors may obtain the data subsequent to the central processing unit 120 completing the obtaining process. For example, the central processing unit 120 may assert a flag which is read by the coprocessors (e.g., via the control registers). The coprocessors may additionally assert the flag when completed with their task (e.g., processing the obtained data. Thus, the central processing unit 120 may set, and unset, flags according to the technique described herein.

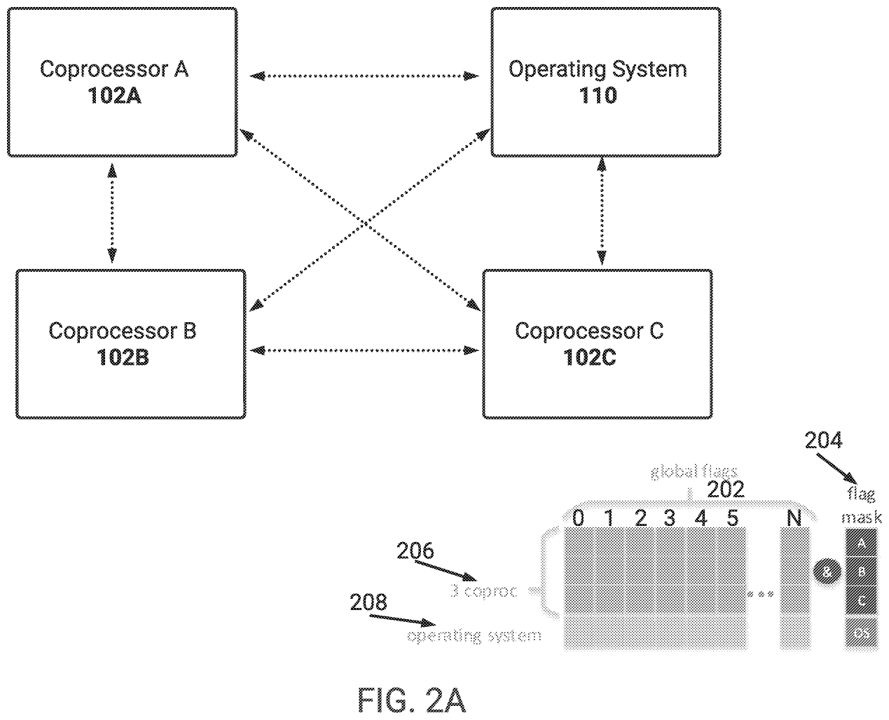

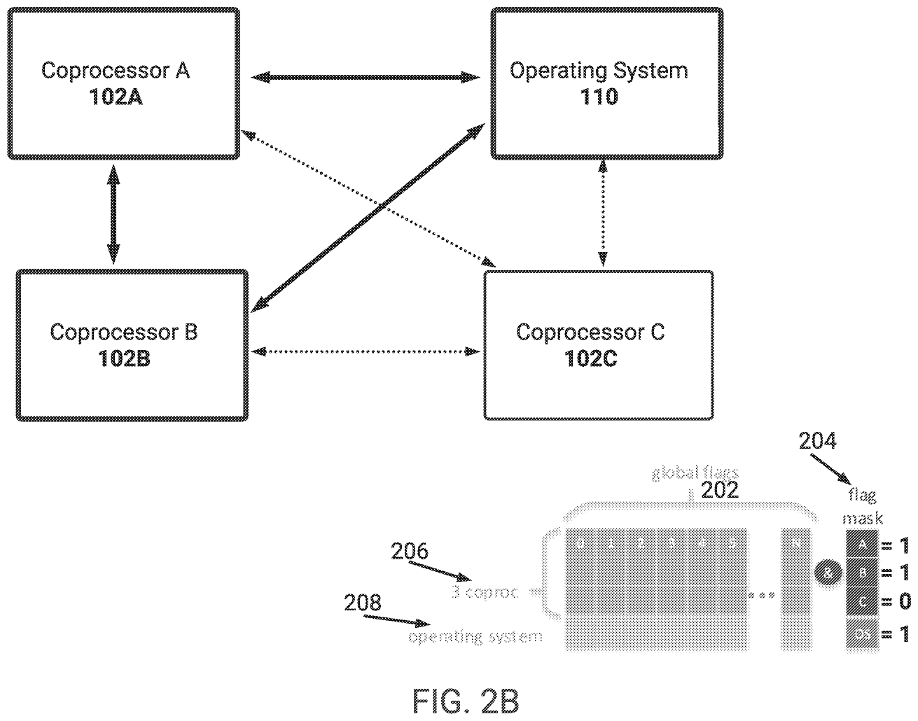

FIG. 2A is a block diagram illustrating a shared mask 204 usable to select a subset of the coprocessors 102A-102C to use global flags 202. In the illustrated example, a representation of the global flags 202 is included. Each of the global flags 0-N is represented as a column, where each row of the column corresponds to one of the coprocessors 206 or operating system 208. Thus, each coprocessor can assert, or de-assert, each of the 0-N flags 202. As described above, in some embodiments a flag may be indicated as being set if all coprocessors, and optionally the operating system (e.g., central processing unit), asserts the flag. Similarly, in some embodiments a flag may be indicated as unset if all coprocessors, and optionally the operating system, de-asserts the flag.

FIG. 2A additionally illustrates a flag mask 204 which may be shared with the coprocessors 102A-102C and operating system 208. The flag mask 204 may be utilized to indicate which of the coprocessors 102A-102C, and optionally operating system 208, are to be involved with the flags. For example, a particular computation task or series of tasks may utilize global flags 0-N 202. In this example, there may be a multitude of dependencies which require different flags to be enforced by the coprocessors 102A-102C and optionally operating system 208. These dependencies may relate to only a subset of the coprocessors 102A-102C and operating system 208, such that the flag mask 208 can remove one or more of actors (e.g., coprocessors, operating system) from enforcing the global flags.

The flag mask 204, in some embodiments, may be provided via the central processing unit. For example, a process scheduler may be running on the central processing unit. In this example, the central processing unit may set the flag mask 204 via one or more control registers which write to the coprocessors (e.g., as described above).

While flag mask 204 is illustrated in FIG. 2A as being associated with global flags 202, as may be appreciated there may be more than one flag mask. For example, each global flag, or a subset of the global flags, may have a flask mask which identifies which of the coprocessors, and optionally operating system 208, are associated with the global flag or subset of the global flags.

FIG. 2B is a block diagram illustrating an example of the shared mask 208 selecting a subset of the coprocessors to use global flags. In FIG. 2B, coprocessors 102A-102B are to be utilized for a particular computation task or series of tasks while coprocessor 102C is not being utilized. For example, coprocessor 102C may be performing other computation tasks or no tasks.

Thus, the flag mask 208 may include a logical 1 for coprocessors 102A-102B, and operating system 208. The flag mask may include a logical 0 for coprocessor C 102C. In this way, the coprocessors 102A-102B and operating system 208 may obtain information identifying that coprocessor C 102C is not to be associated with global flags 202.

### Example Flowchart

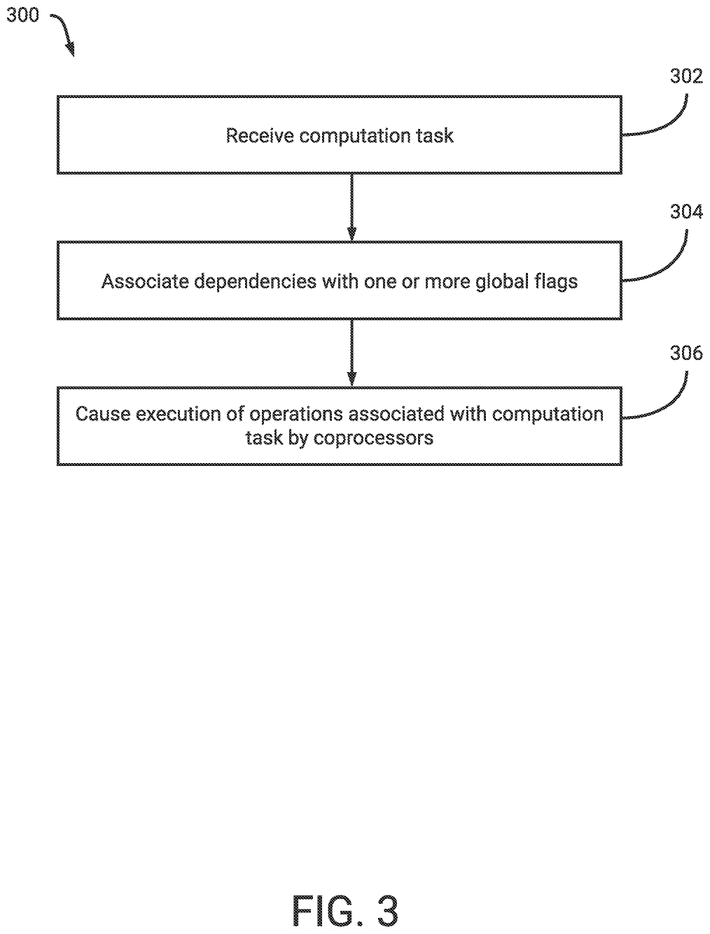

FIG. 3 is a flowchart of an example process 300 for using global flags by an example processor system. For convenience, the process 300 will be described as being performed by a processor system (e.g., processor system 100).

At block 302, the processor system receives a computation task. As described, the computation task may relate to processing, or training, of one or more machine learning models (e.g., neural networks). For example, the machine learning models may be used to determine information usable to effectuate autonomous or semi-autonomous driving of a vehicle. The computation task may include one or more operations which are to be separated into sub-tasks or operations for execution by a multitude of coprocessors (e.g., neural processing units).

At block 304, the processor system associates dependencies with one or more global flags. The computation task may have one or more dependencies, such as data or processing dependencies, which are required to be enforced for the computation task to be completed. For example, each coprocessor may be required to compute certain information which is to be subsequently aggregated, or combined, to form a processing result. In this example, the coprocessors may therefore require a technique by which they can indicate when certain dependencies are complete.

Each flag may thus be associated with a dependency. As the coprocessors complete certain tasks, they can assert one or more global flags to indicate completion of these tasks. As described in FIGS. 1A-1B, the coprocessors may have an all-to-all connection with each other (e.g., via asynchronous wires). In this way, each coprocessor can identify flags being asserted by the remaining coprocessors.

Upon assertion of a flag, which in some embodiments may indicate completion or removal of a particular dependency, the coprocessors may perform subsequent processing. For example, the operations to compute the computation task may require that the particular dependency is completed before additional operations may be performed. In this example, the coprocessors may thus assert a particular flag to indicate that the additional operations are to be performed.

At block 306, the processor system causes execution of operations associated with the computation task. As described above, the coprocessors may perform operations to work towards completion of the computation task. These operations may have data or processing dependencies, such that the coprocessors assert, or de-assert, flags to indicate times at which such dependencies are completed.

While FIG. 3 above-described use of coprocessors asserting, or de-asserting global flags, as described in FIG. 1B additional processors (e.g., a central processing unit) may assert, or de-assert, the global flags. For example, the central processing unit may fetch data from storage for use by one or more of the coprocessors. In this example, the central processing unit may assert a particular flag upon fetching of the data. Additionally, as described in FIGS. 2A-2B, a shared mask may be used to indicate which coprocessors are to be involved in asserting, or de-asserting, global flags.

With respect to a central processing unit, as an example of use of flags the central processing unit may synchronize with another processor which may not have global flags. For example, the other processor may be a graphics processing unit (GPU). As an example, when processing a lengthy neural network there may be operation(s) during the neural network which require the GPU to process information. For this example, the coprocessors (e.g., neural processors) may not have a feature associated with the operation(s). Thus, the global flags may be leveraged to inform the central processing unit when the coprocessors are done with an intermediate result. The central processing unit can then initiate a GPU task which can safely assume that its input data (e.g., the intermediate result) is ready at a known location. Then when the GPU finishes, the central processing unit can set a global flag which indicates that the coprocessors can resume processing the neural network and it can safely assume that the result of this function is available at a known location.

### Vehicle Block Diagram

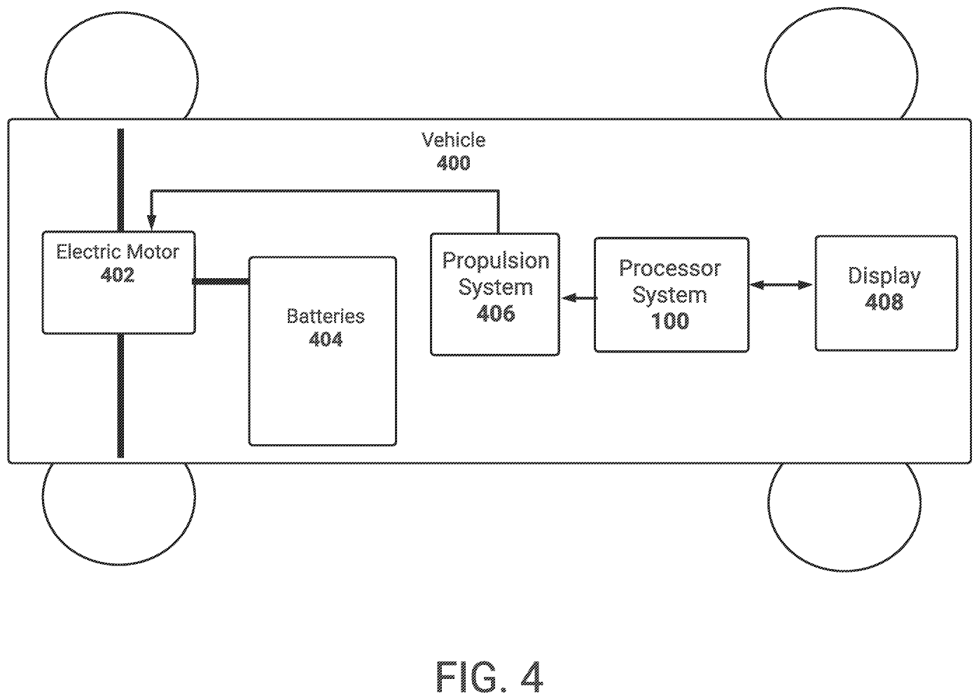

FIG. 4 illustrates a block diagram of a vehicle 400 (e.g., vehicle 102). The vehicle 400 may include one or more electric motors 402 which cause movement of the vehicle 400. The electric motors 402 may include, for example, induction motors, permanent magnet motors, and so on. Batteries 404 (e.g., one or more battery packs each comprising a multitude of batteries) may be used to power the electric motors 402 as is known by those skilled in the art.

The vehicle 400 further includes a propulsion system 406 usable to set a gear (e.g., a propulsion direction) for the vehicle. With respect to an electric vehicle, the propulsion system 406 may adjust operation of the electric motor 402 to change propulsion direction.

Additionally, the vehicle includes the matrix processor system 100 which is configured to perform matrix multiplication using a convolution engine (e.g., matrix processor 110). The matrix processor system 100 may process data, such as images received from image sensors positioned about the vehicle 400 (e.g., cameras). The matrix processor system 100 may additionally output information to, and receive information (e.g., user input) from, a display 408 included in the vehicle 400.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A processor system comprising:
a plurality of coprocessors configured to compute a processing task, wherein individual coprocessors are connected to individual remaining coprocessors via a plurality of connections,
wherein each connection from a coprocessor to a different coprocessor is configured to be asserted, or de-asserted, by the coprocessor to indicate a status associated with a global flag of a plurality of global flags,
and wherein the global flag is set based on the plurality of coprocessors asserting the global flag.

2. The processor system of claim 1, wherein the coprocessors are neural processing units.

3. The processor system of claim 1, wherein each global flag is associated with a dependency.

4. The processor system of claim 3, wherein asserting a particular global flag indicates removal of a particular dependency.

5. The processor system of claim 4, wherein particular operations associated with processing task are initiated based on removal of the particular dependency.

6. The processor system of claim 1, wherein the plurality of connections are asynchronous wires.

7. The processor system of claim 1, wherein the coprocessors utilize a shared mask, and wherein the shared mask indicates which of the coprocessors are to be included in asserting, or de-asserting, the global flags.

8. The processor system of claim 1, wherein the processor system is in communication with a central processing unit via an operation system, and wherein the central processing unit is configured to assert, or de-assert, the flags.

9. The processor system of claim 8, wherein the global flag is set based on the plurality of coprocessors and the central processing unit asserting the global flag.

10. The processor system of claim 8, wherein the central processing unit is configured to write a status of the global flag to a control register, and wherein the operation system routes the status to the coprocessors.

11. The processor system of claim 1, wherein the processing task is associated with a plurality of operations, and wherein the operations are associated with a plurality of dependencies associated with the global flags.

12. A method implemented by a processor system, the method comprising:
receiving a computation task, wherein the computation task is configured to be completed via a plurality of coprocessors included in the processor system, wherein individual coprocessors are connected to individual remaining coprocessors via a plurality of connections, and wherein the computation task is associated with a plurality of dependencies;
associating individual dependencies with individual global flags of a plurality of global flags, wherein each connection from a coprocessor to a different coprocessor is configured to be asserted, or de-asserted, by the coprocessor to indicate a status associated with an individual global flag, and wherein the individual global flag is set based on the plurality of coprocessors asserting the individual global flag; and
causing execution, by the coprocessors, of operations associated with the computation task.

13. The method of claim 12, wherein the coprocessors are neural processing units.

14. The method of claim 12, wherein the plurality of connections are asynchronous wires.

15. The method of claim 12, wherein the coprocessors utilize a shared mask, and wherein the shared mask indicates which of the coprocessors are to be included in asserting, or de-asserting, the global flags.

16. The method of claim 12, wherein the processor system is in communication with a central processing unit via an operation system, and wherein the central processing unit is configured to assert, or de-assert, the flags.

17. The method of claim 16, wherein the global flag is set based on the plurality of coprocessors and the central processing unit asserting the global flag.

18. The method of claim 16, wherein the central processing unit is configured to write a status of the global flag to a control register, and wherein the operation system routes the status to the coprocessors.

19. The method of claim 12, wherein asserting a particular global flag indicates removal of a particular dependency.

20. The method of claim 19, wherein particular operations associated with processing task are initiated based on removal of the particular dependency.
